(19) United States
(12) Patent Application Publication
(10) Pub. No.: US 2019/0355148 A1
(43) Pub. Date: Nov. 21, 2019

(54) IMAGING CONTROL DEVICE, IMAGING CONTROL METHOD, AND PROGRAM

(71) Applicant: FUJIFILM Corporation, Tokyo (JP)

(72) Inventor: Shuhei HORITA, Tokyo (JP)

(73) Assignee: FUJIFILM Corporation, Tokyo (JP)

(21) Appl. No.: 16/529,296

(22) Filed: Aug. 1, 2019

Related U.S. Application Data
(63) Continuation of application No. PCT/JP2018/003180, filed on Jan. 31, 2018.

(30) Foreign Application Priority Data
Feb. 6, 2017 (JP) 2017-019599

(51) Int. Cl. G06T 7/73; G06T 7/246

(52) U.S. Cl. CPC G06T 7/73; G06T 2207/10028; G06T 7/246

(57) ABSTRACT

Provided are an imaging control device, an imaging control method, and a program capable of correctly ascertaining change over time on the same plane of an object to be imaged at low cost. The imaging control device includes a feature point extraction unit (24) that extracts feature points from a first image captured in the past by a first imaging device and a second image captured by a second imaging device, respectively, the feature point extraction unit (24) extracting feature points on the same plane of the object to be imaged in the first image and the second image, a correspondence relationship acquisition unit (26) that acquires a correspondence relationship between the feature point extracted from the first image and the feature point extracted from the second image, the correspondence relationship being a correspondence relationship between the feature points on the same plane of the object to be imaged, and a displacement amount calculation unit that, based on the correspondence relationship between the feature points on the same plane of the object to be imaged, calculates displacement amounts of a position and an attitude of the second imaging device such that differences from a position and an attitude of the first imaging device in a case where the first image is captured fall within given ranges.

### CROSS-REFERENCE TO RELATED APPLICATIONS

The present application is a Continuation of PCT International Application No. PCT/JP2018/003180 filed on Jan. 31, 2018 claiming priority under 35 U.S.C § 119(a) to Japanese Patent Application No. 2017-019599 filed on Feb. 6, 2017. Each of the above applications is hereby expressly incorporated by reference, in their entirety, into the present application.

### BACKGROUND OF THE INVENTION

### 1. Field of the Invention

The present invention relates to an imaging control device, an imaging control method, and a program capable of correctly ascertaining change over time on the same plane of an object to be imaged at low hardware cost.

### 2. Description of the Related Art

In the related art, various techniques for controlling imaging have been suggested or provided.

JP2010-183150A describes a technique that, in a case of performing fixed point imaging with a camera provided in an unfixed state, present information indicating present position, imaging azimuth, and imaging inclination angle of the camera is acquired using a global positioning system (GPS) sensor, a geomagnetic sensor, and an acceleration sensor, past information indicating past position, imaging azimuth, and imaging inclination angle of the camera is acquired from an information memory, and a comparison result of the present information and the past information is displayed to a photographer. The photographer adjusts the present position, imaging azimuth, and imaging inclination angle of the camera referring to the display, whereby it is possible to image a present object to be imaged from the same point of view as in past imaging.

As a social infrastructure, there are many structures, such as bridges and buildings. In these structures, since damage occurs and the damage has a proceeding property, there is a need to inspect the structures at regular intervals. In order to achieve correctness of a result of such inspection, it is desirable to correctly ascertain a damage state of a structure by imaging the structure at regular intervals.

JP2015-111111A describes a technique that a robot is made to move along two cables stretched near a lower surface of a bridge, in a case where the lower surface of the bridge is imaged by a camera mounted on the robot, a present position of the robot is measured by monitoring the rotational drive of the cables, and the robot is made to move to a position in past imaging.

JP2002-048513A describes a technique that, in a case where a robot mounted with two cameras moves freely, a stationary object is determined by continuously imaging a forward view of the robot, and a present position of the robot is detected based on a position of the stationary object. JP1991-252883A (JP-H03-252883A) describes a technique that, in a case of continuously imaging an object for appearance inspection while moving a robot mounted with a rotatable camera, an object image is registered to a center of each image by rotating the camera.

### SUMMARY OF THE INVENTION

According to the technique described in JP2010-183150A, in order to acquire the position, the imaging azimuth, and the imaging inclination angle of the camera, there is a need to prepare various sensors (for example, the GPS sensor, the geomagnetic sensor, and the acceleration sensor) for each camera. Accordingly, there is a problem in that cost and size of hardware are increased.

According to the technique described in JP2015-111111A, since a moving direction of the robot is limited to a longitudinal direction of the cables, it is possible to measure the present position of the robot only by monitoring the rotational drive of the cables; however, in a case where the position of the camera is controllable freely in a two-dimensional manner or in a case where the imaging azimuth or the imaging inclination angle of the camera is controllable freely, the technique is hardly applied. That is, in a case where the position, the imaging azimuth, or the imaging inclination angle of the camera is controllable freely, as described in JP2010-183150A. it is considered that various sensors need to be added, and cost and size of hardware are increased.

JP2002-048513A discloses the technique that the stationary object is determined through continuous imaging of the forward view to detect the present position of the robot, but does not disclose and suggest a suitable configuration for correctly ascertaining change over time on the same plane of an object to be imaged. JP1991-252883A (JP-H03-252883A) discloses the technique that the object image is registered to the center of the image while continuously imaging the object, but does not disclose and suggest a suitable configuration for correctly ascertaining change over time on the same plane of an object to be imaged. Now. JP2002-048513A and JP1991-252883A (JP-H03-252883A) have no description relating to ascertaining change over time of the object to be imaged for each plane.

An object of the invention is to provide an imaging control device, an imaging control method, and a program capable of correctly ascertaining change over time on the same plane of an object to be imaged at low cost.

In order to achieve the above-described object, a first aspect of the invention provides an imaging control device comprising a first image acquisition unit that acquires a first image generated by imaging an object to be imaged by a first imaging device, a second image acquisition unit that acquires a second image generated by imaging the object to be imaged by a second imaging device, a feature point extraction unit that extracts feature points from the first image and the second image, respectively, the feature point extraction unit extracting feature points on the same plane of the object to be imaged in the first image and the second image, a correspondence relationship acquisition unit that acquires a correspondence relationship between the feature point extracted from the first image and the feature point extracted from the second image, the correspondence relationship being a correspondence relationship between the feature points on the same plane of the object to be imaged, and a displacement amount calculation unit that, based on the correspondence relationship between the feature points on the same plane of the object to be imaged, calculates displacement amounts of a position and an attitude of the second imaging device such that differences from a position and an attitude of the first imaging device in a case where the first image is captured fall within given ranges.

According to the aspect, the correspondence relationship between the feature point extracted from the first image and the feature point extracted from the second image, the correspondence relationship between the feature points on the same plane of the object to be imaged is acquired, and the displacement amounts of the position and the attitude of the second imaging device the differences from the position and the attitude of the first imaging device in a case where the first image is captured fall within the given ranges are calculated based on the acquired correspondence relationship. For this reason, it is possible to omit or reduce various sensors (for example, a GPS sensor, a geomagnetic sensor, and an acceleration sensor) for detecting the position and the attitude of the imaging device, and to ascertain change over time of the object to be imaged as change on the same plane of the object to be imaged. Furthermore, the displacement amount is calculated based on the correspondence relationship between solely the feature points that are present in both of the first image and the second image. For this reason, even though new damage occurs in the object to be imaged, the new damage is neglected, and correct displacement amounts are calculated. That is, it is possible to correctly ascertain change over time on the same plane of the object to be imaged with low cost.

According to a second aspect of the invention, the imaging control device further comprises a displacement control unit that controls displacement of the position and the attitude of the second imaging device based on the displacement amounts calculated by the displacement amount calculation unit.

According to a third aspect of the invention, the imaging control device further comprises a coincidence degree calculation unit that calculates a degree of coincidence between the first image and the second image, and a determination unit that compares the degree of coincidence with a reference value to determine whether or not to displace the second imaging device, and the displacement control unit displaces the second imaging device in a case where the determination unit determines to displace the second imaging device.

According to a fourth aspect of the invention, in the imaging control device, the coincidence degree calculation unit calculates the degree of coincidence based on a difference between a position in the first image and a position in the second image of the feature points associated by the correspondence relationship acquisition unit.

According to a fifth aspect of the invention, in the imaging control device, the displacement amount calculation unit calculates the displacement amounts in a case where the determination unit determines to displace the second imaging device.

According to a sixth aspect of the invention, in the imaging control device, in a case where the second imaging device is displaced by the displacement control unit, the acquisition of the image in the second image acquisition unit, the extraction of the feature points in the feature point extraction unit, the acquisition of the correspondence relationship in the correspondence relationship acquisition unit, and the calculation of the degree of coincidence in the coincidence degree calculation unit are repeated.

According to a seventh aspect of the invention, in the imaging control device, the first image and the second image are a stereo image, and the imaging control device further comprises a plane specification unit that specifies planar regions of the object to be imaged in the first image and the second image based on the stereo image.

According to an eighth aspect of the invention, the imaging control device further comprises a three-dimensional information acquisition unit that acquires three-dimensional information of the object to be imaged, and a plane specification unit that specifies planar regions of the object to be imaged in the first image and the second image based on the three-dimensional information.

According to a ninth aspect of the invention, in the imaging control device, the plane specification unit calculates a first plane equation for specifying the planar region of the object to be imaged in the first image and a second plane equation for specifying the planar region of the object to be imaged in the second image, and the correspondence relationship acquisition unit acquires the correspondence relationship between the feature points on the same plane of the object to be imaged using the first plane equation and the second plane equation.

According to a tenth aspect of the invention, the imaging control device further comprises a damage detection unit that detects damage patterns of the object to be imaged from the first image and the second image, and in a case where a damage pattern that is not present in the first image and is present in the second image is detected, the displacement amount calculation unit calculates a displacement amount for registering the damage pattern to a specific position of a third image to be acquired by the second image acquisition unit.

According to an eleventh aspect of the invention, the imaging control device further comprises a display unit, and a display control unit that makes the display unit display the first image and the second image in parallel or in a superimposed manner.

A twelfth aspect of the invention relates to an imaging control method comprising a step of acquiring a first image generated by imaging an object to be imaged by a first imaging device, a step of acquiring a second image generated by imaging the object to be imaged by a second imaging device, a step of extracting feature points from the first image and the second image, respectively, the step being a step of extracting feature points on the same plane of the object to be imaged in the first image and the second image, a step of acquiring a correspondence relationship between the feature point extracted from the first image and the feature point extracted from the second image, the correspondence relationship being a correspondence relationship between the feature points on the same plane of the object to be imaged, and a step of, based on the correspondence relationship between the feature points on the same plane of the object to be imaged, calculating displacement amounts of a position and an attitude of the second imaging device such that differences from a position and an attitude of the first imaging device in a case where the first image is captured fall within given ranges.

A thirteenth aspect of the invention provides a program causing a computer to execute a step of acquiring a first image generated by imaging an object to be imaged by a first imaging device, a step of acquiring a second image generated by imaging the object to be imaged by a second imaging device, a step of extracting feature points from the first image and the second image, respectively, the step being a step of extracting feature points on the same plane of the object to be imaged in the first image and the second image, a step of acquiring a correspondence relationship between the feature point extracted from the first image and the feature point extracted from the second image, the correspondence relationship being a correspondence relationship between the feature points on the same plane of the object to be imaged, and a step of, based on the correspondence relationship between the feature points on the same plane of the object to be imaged, calculating displacement amounts of a position and an attitude of the second imaging device such that differences from a position and an attitude of the first imaging device in a case where the first image is captured fall within given ranges.

According to the invention, it is possible to correctly ascertain change over time on the same plane of the object to be imaged with low cost.

### BRIEF DESCRIPTION OF THE DRAWINGS

FIG. 1 is a block diagram showing a configuration example of an imaging control device in a first embodiment.

FIG. 2 is an explanatory view for use in description of calculation of a displacement amount.

FIG. 3 is a flowchart showing a flow of an imaging control processing example in the first embodiment.

FIG. 4 is an explanatory view for use in description of given ranges.

FIG. 5 is a block diagram showing a configuration example of an imaging control device in a second embodiment.

FIG. 6 is a flowchart showing a flow of an imaging control processing example in the second embodiment.

FIG. 7 is an explanatory view for use in description of a first image were a damage pattern is not present and a second image where a damage pattern is present.

FIG. 8 is an explanatory view for use in description of feature point extraction.

FIG. 9 is an explanatory view for use in description of association of feature points.

FIG. 10 is a block diagram showing a configuration example of an imaging control device in a third embodiment.

FIG. 11 is a flowchart showing a flow of an imaging control processing example in the third embodiment.

FIG. 12 is an explanatory view for use in description of correction of a position of a feature point group of a first image and calculation of a displacement amount for bringing a damage pattern of a second image to a center position of a third image.

FIG. 13 is a perspective view showing an appearance of a bridge as an example of an object to be imaged.

FIG. 14 is a perspective view showing an appearance of a robot device.

FIG. 15 is a sectional view of a main part of the robot device shown in FIG. 14.

FIG. 16 is a perspective view showing an appearance of a stereo camera as an example of an imaging device.

FIG. 17 is a diagram showing the overall configuration of an inspection system.

FIG. 18 is a block diagram showing a configuration example of a main part of a robot device 100 and a terminal device 300 shown in FIG. 17.

FIG. 19 is a diagram showing an image generated by imaging an object to be imaged having a planar region by a stereo camera.

FIG. 20 shows an image for use in description of specification of a planar region.

### DESCRIPTION OF THE PREFERRED EMBODIMENTS

Hereinafter, a mode for carrying out an imaging control device, an imaging control method, and a program according to the invention will be described referring to the accompanying drawings.

### First Embodiment

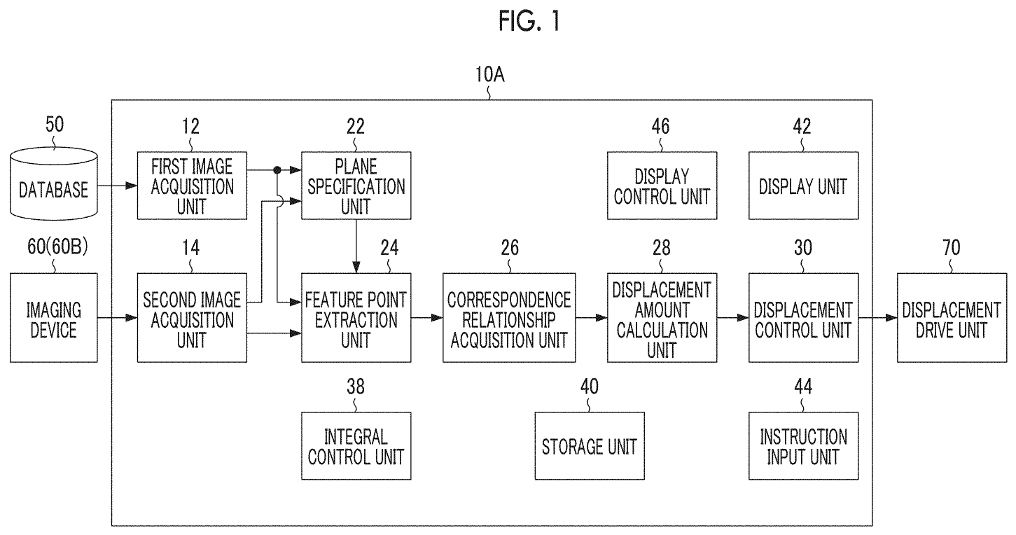

FIG. 1 is a block diagram showing a configuration example of an imaging control device in a first embodiment.

An imaging control device 10A of the embodiment includes a first image acquisition unit 12 that acquires a first image (hereinafter, referred to as a “past image”) indicating a past object to be imaged, a second image acquisition unit 14 that acquires a second image (hereinafter, referred to as a “present image”) indicating a present object to be imaged, a plane specification unit 22 that specifies planar regions of the object to be imaged in the first image and the second image, a feature point extraction unit 24 that extracts feature points from the first image and the second image, the feature point extraction unit 24 extracting feature points on the same plane of the object to be imaged in the first image and the second image, a correspondence relationship acquisition unit 26 that acquires a correspondence relationship between the feature point extracted from the first image and the feature point extracted from the second image, the correspondence relationship being a correspondence relationship between the feature points on the same plane of the object to be imaged, a displacement amount calculation unit 28 that calculates displacement amounts of a position and an attitude of an imaging device 60 based on the correspondence relationship between the feature points on the same plane of the object to be imaged, a displacement control unit 30 that controls displacement of the position and the attitude of the imaging device 60 according to the displacement amounts calculated by the displacement amount calculation unit 28, an integral control unit 38 (a form of a “determination unit”) that integrally controls the units, and a storage unit 40 that stores various kinds of information.

The “first image” is an image generated by imaging the past object to be imaged. The “second image” is an image generated by imaging the present object to be imaged. The imaging device used for imaging of the past object to be imaged (that is, the imaging device that has generated the first image) and the imaging device used for imaging of the present object to be imaged (that is, the imaging device that has generated the second image) may not be the same and may be different. In the specification, regardless of whether the imaging device is the same or different in imaging of the past object to be imaged and imaging of the present object to be imaged, the imaging device 60 used for imaging of the past object to be imaged is referred to as a “first imaging device” and is represented by reference numeral 60A, and the imaging device 60 used for imaging of the present object to be imaged is referred to as a “second imaging device” and is represented by reference numeral 60B. In addition, the first imaging device 60A and the second imaging device 60B may not be of the same type and may be of different types. The “past object to be imaged” and the “present object to be imaged” are the same object, but may be changed in state due to damage or the like.

The “first image” and the “second image” in the example are a stereo image, and become a left eye image (first eye image) and a right eye image (second eye image), respectively. That is, the first imaging device 60A and the second imaging device 60B in the example are a stereo camera.

The first image acquisition unit 12 of the example acquires the first image from a database 50. The database 50 stores the first image generated by imaging the past object to be imaged by the first imaging device 60A in association with an imaging point of the object to be imaged. The first image acquisition unit 12 is configured of, for example, a communication device that accesses the database 50 through a network.

The second image acquisition unit 14 of the example acquires the second image from the second imaging device 60B. That is, the second image acquisition unit 14 of the example acquires the second image generated by imaging the present object to be imaged by the second imaging device 60B from the second imaging device 60B. The second image acquisition unit 14 is constituted of, for example, a communication device that performs communication in a wired or wireless manner.

The plane specification unit 22 of the example calculates a first plane equation for specifying the planar region of the object to be imaged in the first image based on a stereo image constituting the first image, and calculates a second plane equation for specifying the planar region of the object to be imaged in the second image based on the stereo image constituting the second image. A specific example of the specification of the planar regions will be described below in detail.

The feature point extraction unit 24 of the example extracts the feature points on the same plane of the object to be imaged in the first image and the second image. As a feature point extraction technique of the example, known techniques, such as scale invariant feature transform (SIFT), speeded up robust features (SURF), and features from accelerated segment test (FAST), can be used.

The correspondence relationship acquisition unit 26 of the example acquires the correspondence relationship between the feature points on the same plane of the object to be imaged using a known matching technique.

The correspondence relationship acquisition unit 26 of the example acquires the correspondence relationship between the feature points on the same plane of the object to be imaged using the first plane equation and the second plane equation calculated by the plane specification unit 22.

The displacement amount calculation unit 28 of the example calculates a projective transformation (homography) matrix based on the correspondence relationship between the feature point extracted from the first image and the feature point extracted from the second image, specifically, the correspondence relationship between the feature points on the same plane of the object to be imaged, thereby calculates the displacement amounts of the position and the attitude of the second imaging device 60B. The matching between the feature points in the correspondence relationship acquisition unit 26 and the calculation of the displacement amounts in the displacement amount calculation unit 28 may be performed simultaneously.

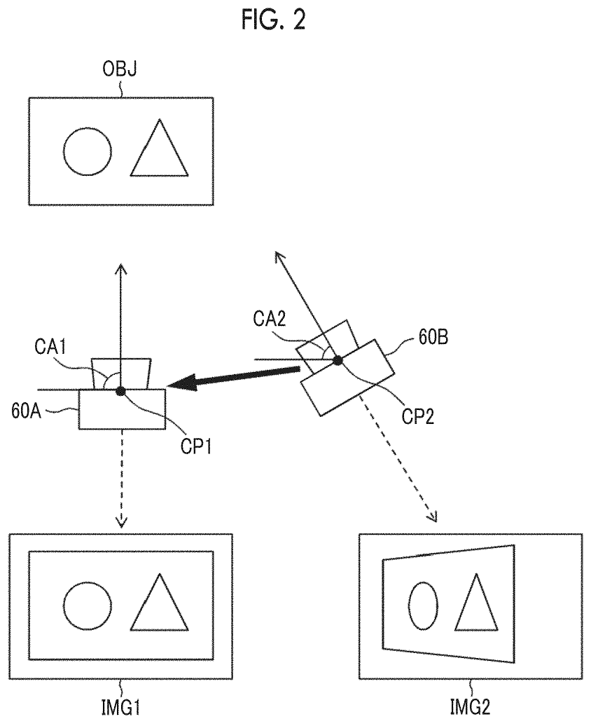

As illustrated in FIG. 2, the displacement amount calculation unit 28 calculates a difference (CP2−CP1) between a position CP1 of the first imaging device 60A and a position CP2 of the second imaging device 60B in a three-dimensional space and a difference (CA2−CA1) between an imaging inclination angle CA1 indicating the attitude of the first imaging device 60A and an imaging inclination angle CA2 indicating the attitude of the second imaging device 60B based on the correspondence relationship between a feature point extracted from a first image IMG1 and a feature point extracted from a second image IMG2, specifically, the correspondence relationship between feature points on the same plane of an object to be imaged OBJ. In the example shown in FIG. 2, since the imaging inclination angle (CA1) of the first imaging device 60A to be a target is 90 degrees, an imaging azimuth is neglected, and only the difference (CA2−CA1) in imaging inclination angle is calculated as the difference as the difference in attitude. In a case where the imaging inclination angle (CA1) of the first imaging device 60A is not 90 degrees, the difference in imaging azimuth is also calculated, and the difference in imaging azimuth is also included in the difference in attitude. The displacement amount calculation unit 28 decides the displacement amount of the position of the second imaging device 60B based on the difference in position (CP2−CP1), and decides the displacement amount of the attitude of the second imaging device 60B based on the difference in attitude (in the example, CA2-CA1). The displacement control unit 30 performs control such that the position CP2 and the attitude (in the example, the imaging inclination angle CA2) of the second imaging device 60B is made to be close to the position CP1 and the attitude (in the example, the imaging inclination angle CA1) of the first imaging device 60A. Even though the position and the attitude to be a target are decided, there is a case where it is hard to perform displacement to the position and the attitude that are completely the same as the target. Accordingly, the displacement amounts for making the differences from the position and the attitude to be a target fall within given ranges. The displacement amount calculation unit 28 of the example calculates the displacement amounts of the position and the attitude of the second imaging device 60B for making the differences from the position and the attitude of the first imaging device 60A (the position and the attitude of the first imaging device 60A in a case where the first image is generated by imaging the past object to be imaged by the first imaging device 60A) fall within the given ranges.

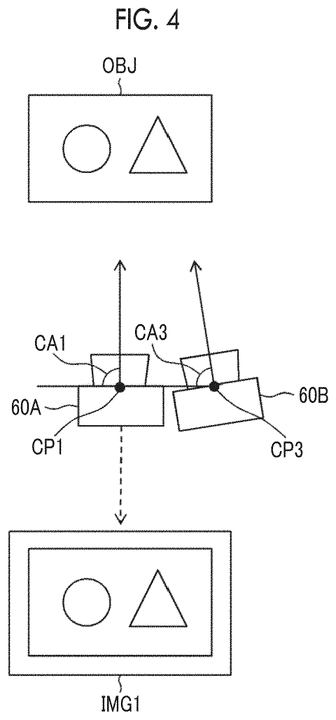

For example, as shown in FIG. 4, the “given ranges” of the position and the attitude refer to a case where an absolute value of the difference (CP3−CP1) between the position CP1 of the first imaging device 60A and a position CP3 of the second imaging device 60B after displacement in the three-dimensional space is within a threshold and an absolute value of the difference (CA3−CA1) between the angle CA1 indicating the attitude of the first imaging device 60A and an angle CA3 indicating the attitude of the second imaging device 60B is within a threshold.

The displacement control unit 30 of the example controls displacement of the position and the attitude of the second imaging device 60B using a displacement drive unit 70 according to the displacement amounts calculated by the displacement amount calculation unit 28. The displacement drive unit 70 of the example can change the position of the imaging device 60 in the three-dimensional space. The displacement drive unit 70 of the example can change the imaging azimuth and the imaging inclination angle of the imaging device 60 with a pan operation of the imaging device 60 and a tilt operating of the imaging device 60, respectively. In the specification, the change of the position of the imaging device 60 in the three-dimensional space and the change of the attitude (imaging azimuth and imaging inclination angle) of the imaging device 60 are collectively referred to as “displacement”. A specific example of the displacement drive will be described below in detail.

The integral control unit 38 of the example controls the units of the imaging control device 10A according to a program.

The displacement control unit 30, the plane specification unit 22, the feature point extraction unit 24, the correspondence relationship acquisition unit 26, the displacement amount calculation unit 28, the displacement control unit 30, and the integral control unit 38 of the example are constituted of a central processing unit (CPU).

The storage unit 40 of the example is constituted of a transitory storage device and a non-transitory storage device. The transitory storage device is, for example, a random access memory (RAM). The non-transitory storage device is, for example, a read only memory (ROM) or an electrically erasable programmable read only memory (EEPROM). The non-transitory storage device stores the program.

The display unit 42 performs various kinds of display. The display unit 42 is constituted of a display device, such as a liquid crystal display.

The instruction input unit 44 receives an input of an instruction from a user. For the instruction input unit 44, various input devices can be used.

The display control unit 46 is constituted of, for example, the CPU, and controls the display unit 42. The display control unit 46 of the example makes the display unit 42 display the first image and the second image in parallel or in a superimposed manner.

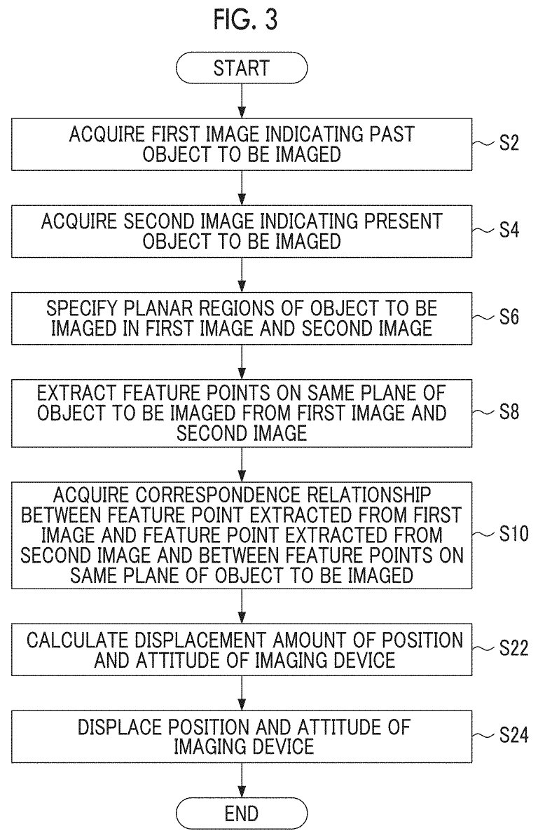

FIG. 3 is a flowchart showing a flow of an imaging control processing example in the first embodiment. The imaging control processing of the example is executed according to the program under the control of the CPU constituting the integral control unit 38 and the like.

First, the first image indicating the past object to be imaged is acquired from the database 50 by the first image acquisition unit 12 (Step S2).

Furthermore, the second image indicating the present object to be imaged is acquired from the imaging device 60 by the second image acquisition unit 14 (Step S4).

Next, the planar region of the object to be imaged in the first image and the planar region of the object to be imaged in the second image are specified by the plane specification unit 22 (Step S6).

Next, the feature points on the same plane of the object to be imaged are extracted from the first image and the second image by the feature point extraction unit 24 (Step S8). That is, in extracting the feature points from the first image and the second image, the feature points are extracted from the planar region of the first image and the planar region of the second image corresponding to the same plane of the object to be imaged.

Next, the correspondence relationship between the feature point extracted from the first image and the feature point extracted from the second image, specifically, the correspondence relationship between the feature points on the same plane of the object to be imaged is acquired by the correspondence relationship acquisition unit 26 (Step S10).

Next, the displacement amounts of the position and the attitude of the second imaging device 60B for making the differences between the position and the attitude of the second imaging device 60B and the position and the attitude of the first imaging device 60A at the time of capturing the first image fall within the given ranges are calculated based on the correspondence relationship between the feature points on the same plane of the object to be imaged by the displacement amount calculation unit 28 (Step S22).

Next, the position and the attitude of the imaging device 60 are displaced according to the calculated displacement amounts by the displacement control unit 30 (Step S24).

### Second Embodiment

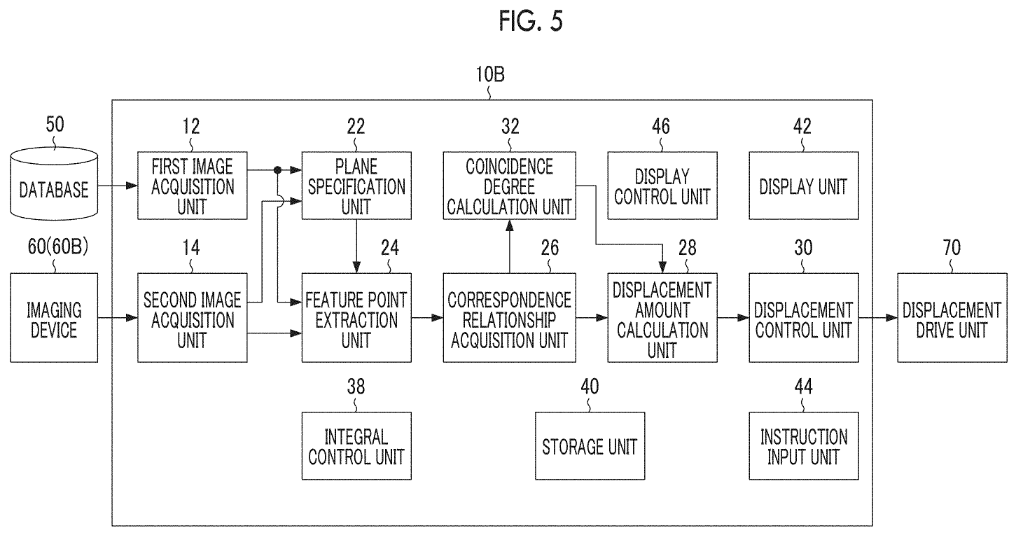

FIG. 5 is a block diagram showing a configuration example of an imaging control device 10B in a second embodiment. The same constituent elements as those of the imaging control device 10A in the first embodiment shown in FIG. 1 are represented by the same reference numerals, and description of the constituent elements already described will not be repeated below.

The imaging control device 10B of the embodiment comprises a coincidence degree calculation unit 32 that calculates a degree of coincidence between the first image indicating the past object to be imaged and the second image indicating the present object to be imaged.

The coincidence degree calculation unit 32 of the example calculates the degree of coincidence based on a difference between a position in the first image and a position of the second image of the feature points associated by the correspondence relationship acquisition unit 26.

The integral control unit 38 (a form of a “determination unit”) of the example compares the degree of coincidence calculated by the coincidence degree calculation unit 32 with a reference value to determine whether or not to displace the second imaging device 60B.

The displacement amount calculation unit 28 of the example calculates the displacement amounts in a case where the integral control unit 38 (determination unit) determines to displace the second imaging device 60B, and does not calculate the displacement amounts in a case where the integral control unit 38 (determination unit) determines not to displace the second imaging device 60B.

The displacement control unit 30 of the example displaces the second imaging device 60B in a case where the integral control unit 38 (determination unit) determines to displace the second imaging device 60B, and does not displace the second imaging device 60B in a case where the integral control unit 38 (determination unit) determines not to displace the second imaging device 60B.

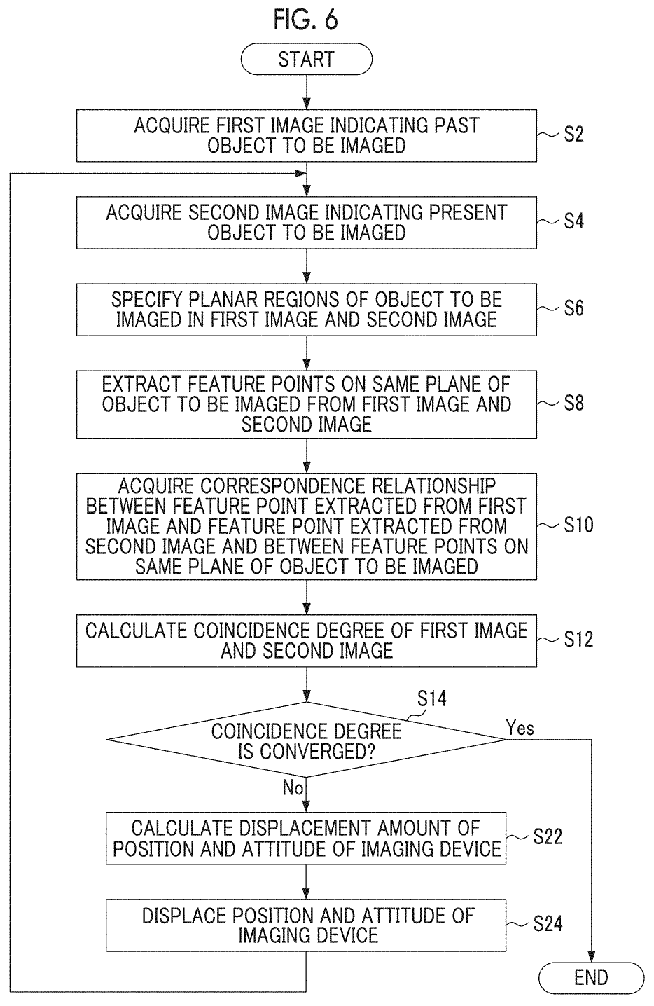

FIG. 6 is a flowchart showing a flow of an imaging control processing example in the second embodiment. The imaging control processing of the example is executed according to the program under the control of the CPU constituting the integral control unit 38. The same steps as those in the flowchart of the first embodiment shown in FIG. 3 are represented by the same reference numerals, and description of the steps already described will not be repeated below.

Steps S2 to S10 are the same as those in the first embodiment.

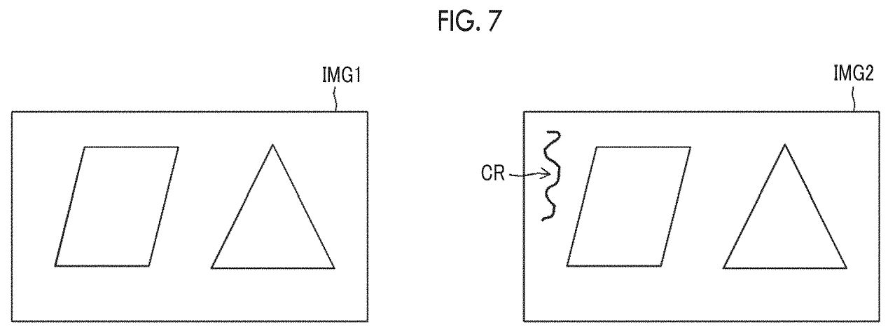

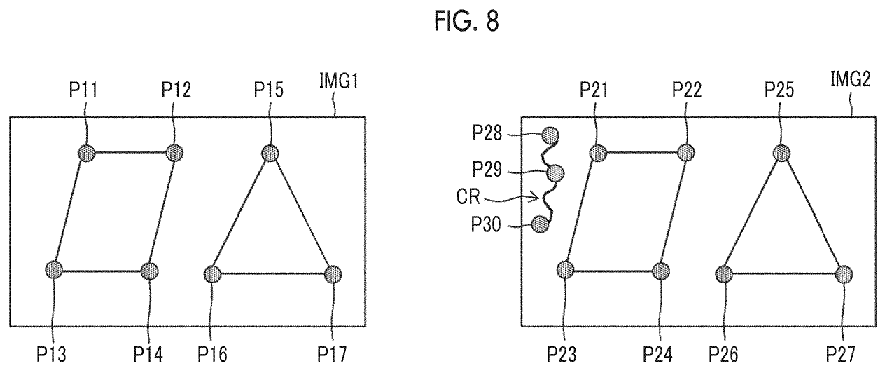

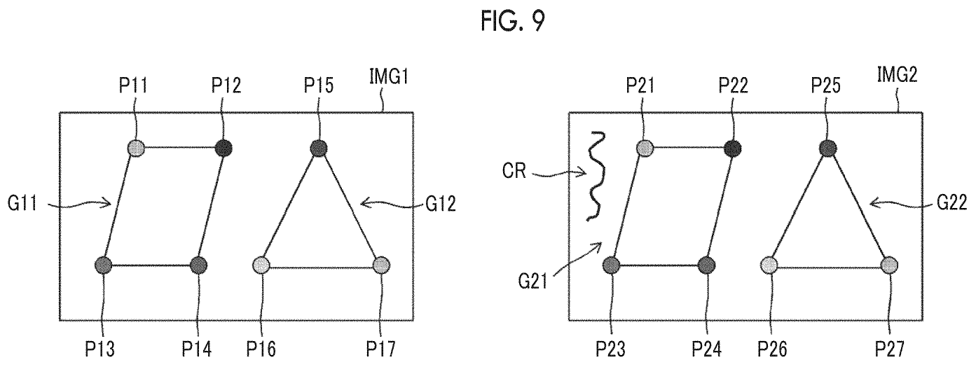

As shown in FIG. 7, it is assumed that a crack image CR (damage pattern) is not present in the first image IMG1 acquired in Step S2, and a crack image CR (damage pattern) is present in the second image IMG2 acquired in Step S4. In feature point extraction of Step S8, as shown in FIG. 8, it is assumed that feature points P11 to P17 are extracted from the first image IMG1, and feature points P21 to P30 are extracted from the second image IMG2. In correspondence relationship acquisition of Step S10, as shown in FIG. 9, a correspondence relationship between feature points of corresponding feature point groups (G11 and G21, G12 and G22) in the first image IMG1 and the second image IMG2 is acquired, and the crack image CR (damage pattern) that is present only in the second image IMG2 is neglected.

In Step S12, the degree of coincidence between the first image and the second image is calculated by the coincidence degree calculation unit 32. The coincidence degree calculation unit 32 of the example calculates an evaluation value MV as the degree of coincidence according to the following expression.

$$MV = \frac{{\sum }_{i} \{ {( {Xr}_{i} - {Xs}_{i} )}^{2} + {( {Yr}_{i} - {Ys}_{i} )}^{2} \}}{n} \qquad ( 1 )$$

In Expression (1), Xri and Yri are coordinates indicating the position in the first image IMG1 of each of the feature points P11 to P17 of the first image IMG1. Xsi and Ysi are coordinates indicating the position in the second image IMG2 of each of the feature points P21 to P27 (the feature points associated with the feature points P11 to P17 of the first image IMG1 by the correspondence relationship acquisition unit 26) excluding the feature points P28 to P30 of the crack image CR (damage pattern) among the feature points P21 to P30, n is the number of corresponding feature points (the number of correspondence points). i is an identification number of a feature point, and is an integer of 1 to n.

As the evaluation value MV, the following expression may be used.

MV=Max{(Xrᵢ−Xsᵢ)²+(Yrᵢ−Ysᵢ)²} (i=1˜n) (2)

That is, as the evaluation value MV, a maximum value of deviation (difference) of each corresponding feature point (each correspondence point) is calculated.

In a case where the number of corresponding feature points is constant, the following expression may be used.

$$MV = {\sum }_{i} \{ {( {Xr}_{i} - {Xs}_{i} )}^{2} + {( {Yr}_{i} - {Ys}_{i} )}^{2} \} \qquad ( 3 )$$

The evaluation value MV shown in Expressions (1) to (3) indicates that the smaller the value, the more the two images coincide with each other. However, the invention is not limited to such a case, an evaluation value indicating that the greater the value, the more the two images coincide with each other may be used.

Next, the integral control unit 38 determines whether or not the degree of coincidence between the first image and the second image is converged (Step S14).

The “reference value” of the example is a threshold indicating an allowable value of an error of coincidence of the positions in the images of the corresponding feature point groups in the first image and the second image. For example, in FIG. 9, the evaluation value MV indicating the degree of coincidence between the positions in the images of the feature point groups G11 and G12 of the first image and the feature point groups G21 and G22 of the second image is compared with the reference value.

The evaluation value (the evaluation value MV of Expression (1), (2), or (3)) of the example indicates that the smaller the value, the more the two images coincide with each other. For this reason, in a case where determination is made that the evaluation value MV calculated by the coincidence degree calculation unit 32 is less than the reference value (in Step S14, Yes), the processing ends. That is, determination is made that a desired position is reached, and the processing ends.

In a case where determination is made in Step S14 that the degree of coincidence is not converged, the displacement amounts of the position and the attitude of the second imaging device 60B are calculated by the displacement amount calculation unit 28 (Step S22), the position and the attitude of the second imaging device 60B are displaced by the displacement control unit 30 (Step S24), and the process returns to Step S4. That is, the acquisition of the image in the second image acquisition unit 14 (Step S4), the specification of the planar regions in the plane specification unit 22 (Step S6), the extraction of the feature points in the feature point extraction unit 24 (Step S8), the acquisition of the correspondence relationship between the feature points of the first image and the second image in the correspondence relationship acquisition unit 26 (Step S10), and the calculation of the degree of coincidence in the coincidence degree calculation unit 32 (Step S12) are repeated. The specification of the planar regions (Step S6) and the extraction of the feature points (Step S8) may be performed only on the second image indicating the present object to be imaged. Steps S22 and S24 are the same as those in the first embodiment.

In a case where an evaluation value indicating that the greater the value, the more the two images coincide with each other is used as the degree of coincidence, it should be noted that the magnitude relationship between the evaluation value and the reference value is reversed. That is, in Step S14, in a case where the evaluation value indicating the degree of coincidence is equal to or greater than the reference value, determination is made that the degree of coincidence is converged (in Step S14, Yes), and in a case where the evaluation value indicating the degree of coincidence is less than the reference value, determination is made that the degree of coincidence is not converged (in Step S14, No).

### Third Embodiment

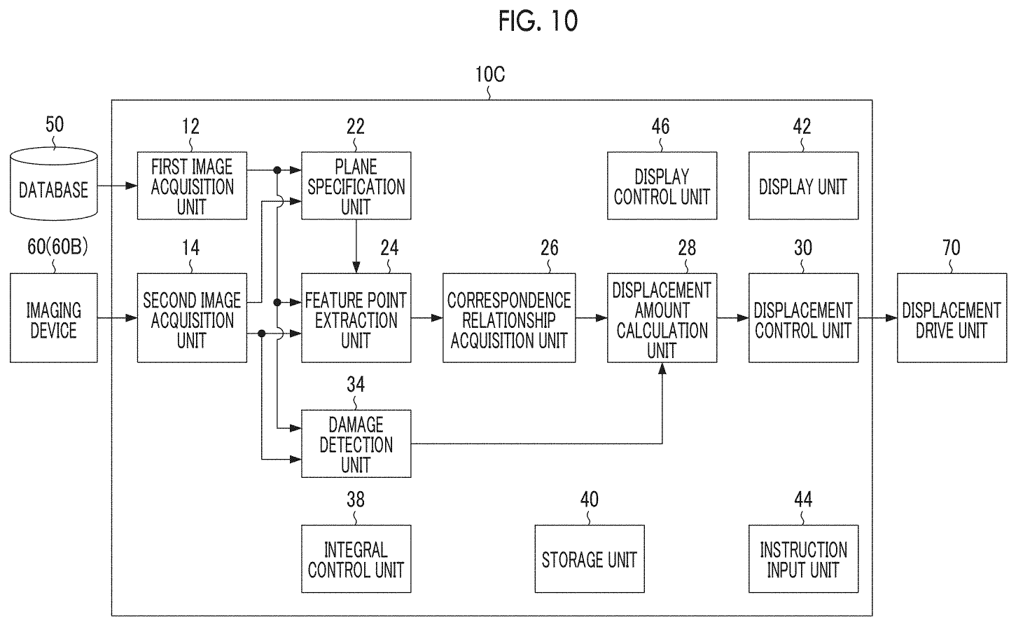

FIG. 10 is a block diagram showing a configuration example of an imaging control device 10C in a third embodiment. The same constituent elements as those of the imaging control device 10A in the first embodiment shown in FIG. 1 are represented by the same reference numerals, and description of the constituent elements already described will not be repeated below.

The imaging control device 10C of the embodiment comprises a damage detection unit 34 that detects damage patterns of the object to be imaged from the first image indicating the past object to be imaged and the second image indicating the present object to be imaged.

The displacement amount calculation unit 28 of the example is configured to, in a case where a damage pattern that is not present in the first image indicating the past object to be imaged and is present in the second image indicating the present object to be imaged is detected, calculate a displacement amount for registering the detected damage pattern to a specific position of an image (hereinafter, referred to as a “third image”) to be newly acquired by the second image acquisition unit 14.

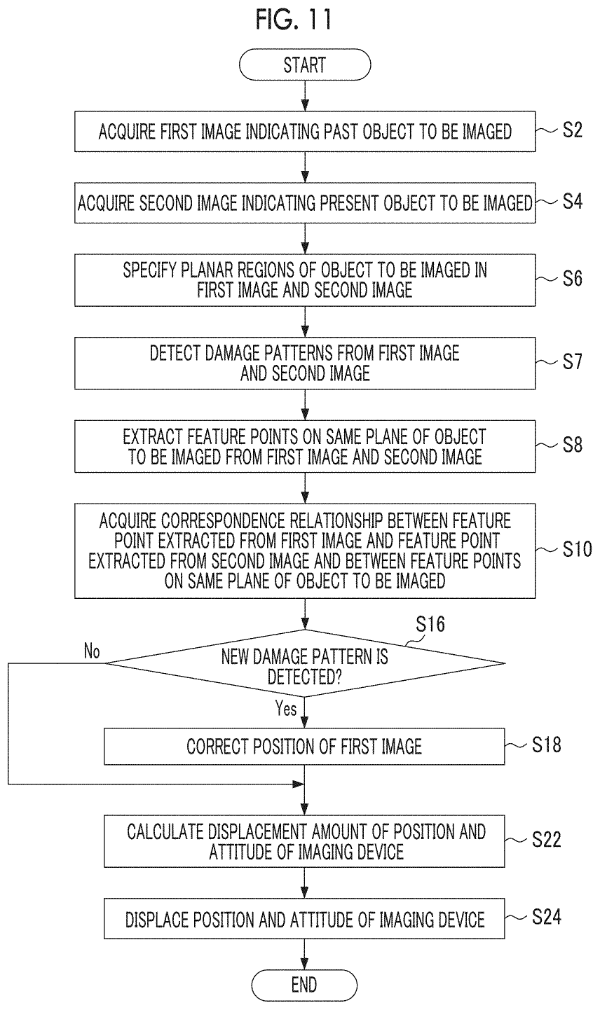

FIG. 11 is a flowchart showing a flow of an imaging control processing example in the third embodiment. The imaging control processing of the example is executed according to the program under the control of the CPU constituting the integral control unit 38 and the like. The same steps as those in the flowchart of the first embodiment shown in FIG. 3 are represented by the same reference numerals, and description of the steps already described will not be repeated below.

Steps S2 to S6 are the same as those in the first embodiment.

In Step S7, the crack image CR (damage pattern) of the object to be imaged is detected from the first image IMG1 and the second image IMG2 shown in FIG. 7 by the damage detection unit 34. In the example shown in FIG. 7, the damage pattern is not detected from the first image IMG1, and the damage pattern is detected from the second image IMG2.

Steps S8 and Step S10 are the same as those in the first embodiment.

In Step S16, the integral control unit 38 determines whether or not the damage pattern that is not present in the first image IMG1 and is present in the second image IMG2 is detected, and in a case where the damage pattern is detected, Step S18 is executed.

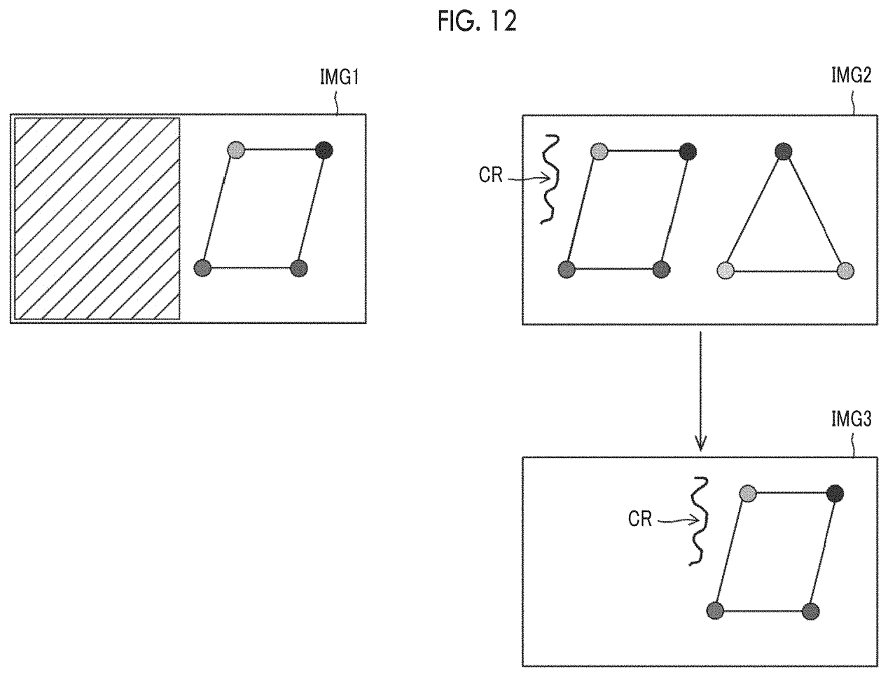

In Step S18, as shown in FIG. 12, the position of the feature point group of the first image IMG1 indicating the past object to be imaged is corrected by the displacement amount calculation unit 28, and in Step S22, a displacement amount for registering the detected crack image CR to the specific position of the image (third image) to be newly acquired by the second image acquisition unit 14 is calculated by the displacement amount calculation unit 28. In the example shown in FIG. 12, the displacement amount is calculated such that the crack image CR (damage pattern) is brought to a center position of the right and left of a third image IMG3 (a position corresponding to the center of an angle of view of the imaging device 60). In FIG. 12, a hatched portion indicates a portion not included in the first image IMG1, and the hatched portion is not used for calculating the displacement amount.

[Example of Object to be Imaged]

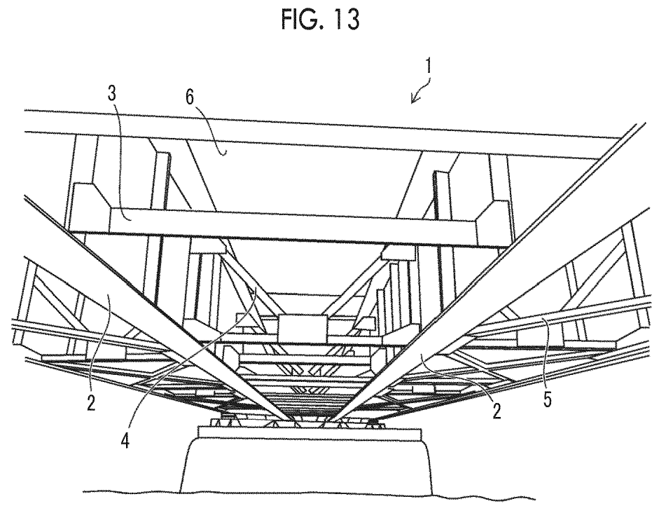

FIG. 13 is a perspective view showing an appearance of a bridge as an example of an object to be imaged. A bridge 1 shown in FIG. 13 includes main girders 2, cross beams 3, cross frames 4, and lateral frames 5. Deck slabs 6 that are members made of concrete are placed on the main girders 2 and the like. The main girders 2 are members that support the weights of vehicles or the like on the deck slabs 6. The cross beams 3, the cross frames 4, and the lateral frames 5 are members that connect the main girders 2.

The “object to be imaged” in the invention is not limited to the bridge, and the object to be imaged may be, for example, a building or an industrial product.

[Example of Displacement Drive]

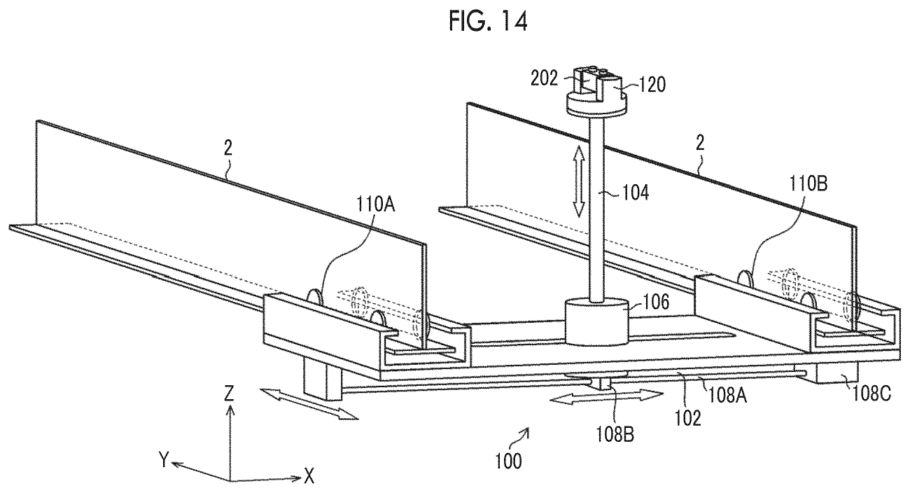

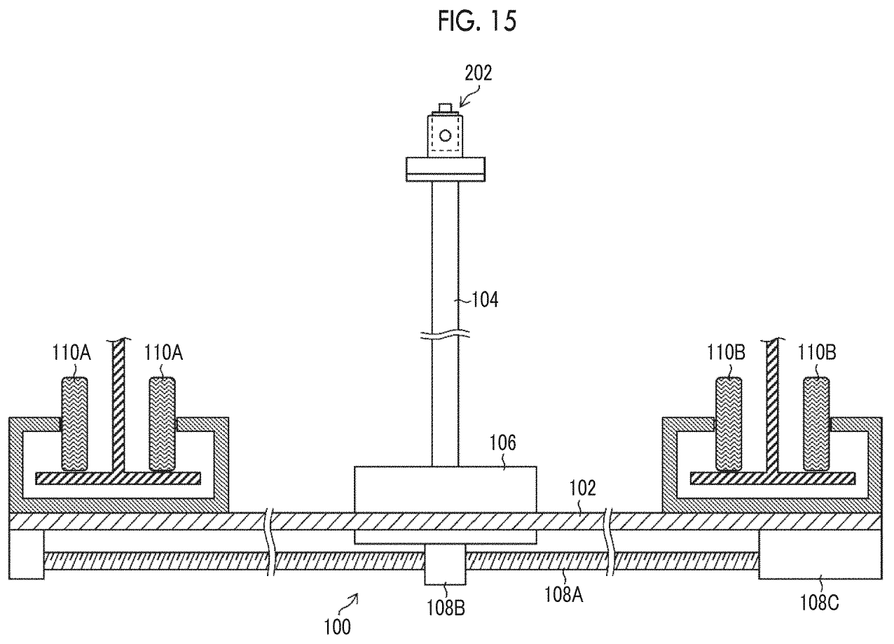

FIG. 14 is a perspective view showing an appearance of a robot device mounted with a stereo camera as an example of an imaging device, and shows a state in which the robot device is provided between the main girders 2 of the bridge 1. FIG. 15 is a sectional view of a main part of the robot device shown in FIG. 14.

A robot device 100 shown in FIGS. 14 and 15 is mounted with a stereo camera 202, controls a position (hereinafter, referred to as an “imaging position”) of the stereo camera 202, controls an attitude (imaging azimuth and imaging inclination angle) of the stereo camera 202, and makes the stereo camera 202 image the bridge 1.

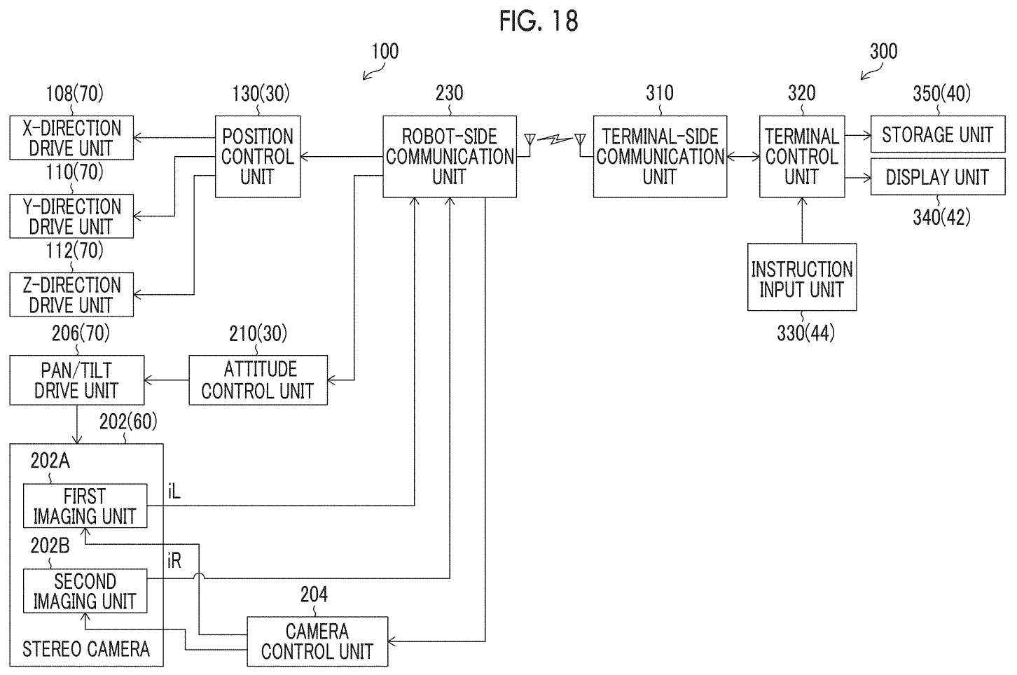

The robot device 100 includes a main frame 102, a vertical telescopic arm 104, and a housing 106. Inside the housing 106, an X-direction drive unit 108 (FIG. 18) that moves the housing 106 in an X direction (in the example, a longitudinal direction of the main frame 102, that is, a direction perpendicular to the longitudinal direction of the main girder 2) to displace the stereo camera 202 in the X direction, a Y-direction drive unit 110 (FIG. 18) that moves the entire robot device 100 in a Y direction (in the example, the longitudinal direction of the main girder 2) to displace the stereo camera 202 in the Y direction, and a Z-direction drive unit 112 (FIG. 18) that makes the vertical telescopic arm 104 expand and contract in a Z direction (in the example, a vertical direction) to displace the stereo camera 202 in the Z direction are provided.

The X-direction drive unit 108 is constituted of a ball screw 108A that is provided in the longitudinal direction (X direction) of the main frame 102, a ball nut 108B that is provided in the housing 106, and a motor 108C that rotates the ball screw 108A, and rotates the ball screw 108A in a normal direction or a reverse direction by the motor 108C to move the housing 106 in the X direction.

The Y-direction drive unit 110 is constituted of tires 110A and 110B that are provided at both ends of the main frame 102, and motors (not shown) that are provided in the tires 110A and 110B, and drives the tires 110A and 110B by the motors to move the entire robot device 100 in the Y direction.

The robot device 100 is provided in an aspect in which the tires 110A and 110B at both ends of the main frame 102 are disposed on lower flanges of the two main girders 2, and are disposed such that the main girders 2 are sandwiched between the tires 110A and 110B. With this, the robot device 100 can move (be self-propelled) along the main girders 2 while being suspended from the lower flanges of the main girders 2. The main frame 102 is configured such that the length of the main frame 102 can be adjusted according to an interval between the main girders 2.

The vertical telescopic arm 104 is provided in the housing 106 of the robot device 100, and moves in the X direction and the Y direction along with the housing 106. The vertical telescopic arm 104 expands and contracts in the Z direction by the Z-direction drive unit 112 (FIG. 18) provided in the housing 106.

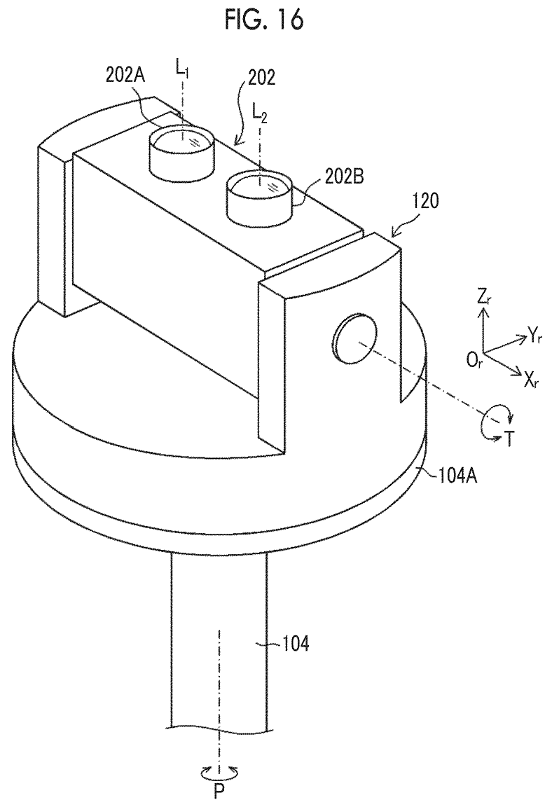

As shown in FIG. 16, a camera mounting portion 104A is provided at a distal end of the vertical telescopic arm 104, and the stereo camera 202 that can be rotated in a pan direction (a direction around a pan axis P) and a tilt direction (a direction around a tilt axis T) by a pan/tilt mechanism 120 is provided in the camera mounting portion 104A.

The stereo camera 202 has a first imaging unit 202A and a second imaging unit 202B that captures a stereo image having two images (left eye image and right eye image) with different parallax, functions as a part of a first space information acquisition unit that acquires first space information of the object to be imaged (in the example, the bridge 1) corresponding to an imaging range of the stereo camera 202, specifically, first space information of the bridge 1 in a local coordinate system (camera coordinate system) based on the stereo camera 202, and acquires at least one of two images to be captured as an “inspection image” to be attached to an inspection report.

The stereo camera 202 is rotated around the pan axis P coaxial with the vertical telescopic arm 104 or is rotated around the tilt axis T in a horizontal direction by the pan/tilt mechanism 120, to which a driving force is applied from a pan/tilt drive unit 206 (FIG. 18). With this, the stereo camera 202 can perform imaging of any attitude (imaging of any imaging azimuth and imaging of any imaging inclination angle).

An optical axis L₁ of the first imaging unit 202A and an optical axis L₂ of the second imaging unit 202B of the stereo camera 202 of the example are parallel to each other. The pan axis P is perpendicular to the tilt axis T. A base line of the stereo camera 202 (that is, an interval at which the first imaging unit 202A and the second imaging unit 202B are provided) is known.

The camera coordinate system based on the stereo camera 202 has a cross point of the pan axis P and the tilt axis T as an origin Or, a direction of the tilt axis T as an x-axis direction, a direction of the pan axis P as a z-axis direction, and a direction perpendicular to the x axis and the y axis as a y-axis direction.

<Configuration Example of Inspection System>

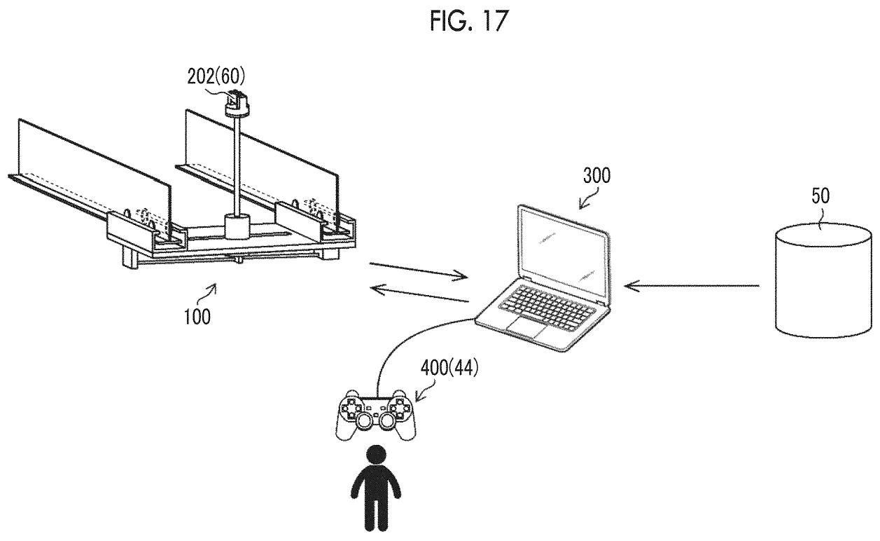

FIG. 17 shows an overall configuration example of an inspection system to which the imaging control device according to the invention is applied. As shown in FIG. 17, the inspection system of the example includes the database 50, the robot device 100 mounted with the stereo camera 202 (a form of the imaging device 60), a terminal device 300, and an operation controller 400.

FIG. 18 is a block diagram showing a configuration example of a main part of the robot device 100 and the terminal device 300 shown in FIG. 17.

As shown in FIG. 18, the robot device 100 includes the X-direction drive unit 108, the Y-direction drive unit 110, the Z-direction drive unit 112, a position control unit 130, the pan/tilt drive unit 206, an attitude control unit 210, a camera control unit 204, and a robot-side communication unit 230.

The robot-side communication unit 230 performs bidirectional wireless communication with a terminal-side communication unit 310, receives various commands (for example, a position control command to command position control of the stereo camera 202, an attitude control command to command attitude control of the stereo camera 202, and an imaging command to control imaging of the stereo camera 202) to be transmitted from the terminal-side communication unit 310, and outputs the received commands to corresponding control units. Details of the terminal device 300 will be described below.

The position control unit 130 controls the X-direction drive unit 108, the Y-direction drive unit 110, and the Z-direction drive unit 112 based on the position control command input from the robot-side communication unit 230, moves the robot device 100 in the X direction and the Y direction, and makes the vertical telescopic arm 104 expand and contract in the Z direction (see FIG. 14).

The attitude control unit 210 operates the pan/tilt mechanism 120 in the pan direction and the tilt direction through the pan/tilt drive unit 206 based on the attitude control command input from the robot-side communication unit 230, and makes the stereo camera 202 pan and tilt in a desired direction (see FIG. 16).

The camera control unit 204 makes the first imaging unit 202A and the second imaging unit 202B of the stereo camera 202 capture a live view image or an inspection image based on the imaging command input from the robot-side communication unit 230.

Image data indicating a left eye image iL and a right eye image iR with different parallax captured by the first imaging unit 202A and the second imaging unit 202B of the stereo camera 202 at the time of inspection of the bridge 1 is transmitted to the terminal-side communication unit 310 through the robot-side communication unit 230.

The terminal device 300 includes the terminal-side communication unit 310 (an form of the first image acquisition unit 12 and the second image acquisition unit 14), a terminal control unit 320 (an form of the plane specification unit 22, the feature point extraction unit 24, the correspondence relationship acquisition unit 26, the displacement amount calculation unit 28, the coincidence degree calculation unit 32, the damage detection unit 34, the integral control unit 38, and the display control unit 46), an instruction input unit 330, a display unit 340, and a storage unit 350. As the terminal device 300, for example, a personal computer or a tablet terminal can be used.

The terminal-side communication unit 310 performs bidirectional wireless communication with the robot-side communication unit 230, receives various kinds of information (receives the images captured by the first imaging unit 202A and the second imaging unit 202B) input from the robot-side communication unit 230, and transmits various commands according to operations on the instruction input unit 330 input through the terminal control unit 320 to the robot-side communication unit 230.

The terminal control unit 320 outputs the images received through the terminal-side communication unit 310 to the display unit 340, and displays the images on a screen of the display unit 340. The instruction input unit 330 outputs the position control command to change the position of the stereo camera 202 in the X direction, the Y direction, and the Z direction, the attitude control command to change the attitude (imaging azimuth and imaging inclination angle) of the stereo camera 202, and the imaging command to command capturing of the images in the stereo camera 202. An inspector manually operates the instruction input unit 330 while viewing the images displayed on the display unit 340. The instruction input unit 330 outputs various commands, such as the position control command, the attitude control command, and the imaging command of the stereo camera 202 to the terminal control unit 320 according to the operations of the inspector. The terminal control unit 320 transmits various commands input to the instruction input unit 330 to the robot-side communication unit 230 through the terminal-side communication unit 310.

The terminal control unit 320 has a function of acquiring member identification information for specifying each member constituting the object to be imaged (in the example, the bridge 1) included in the images based on information stored in the storage unit 350.

[Specification Example of Planar Region]

The first image and the second image of the example are a stereo image, and the plane specification unit 22 can calculate parallax based on the stereo image and can specify the planar regions based on pixel position and parallax. The feature point extraction unit 24 can extract the feature points on the same plane of the object to be imaged from the first image and the second image based on a plane specification result of the plane specification unit 22.

The specification of the planar regions can be performed, for example, using a random sample consensus (RANSAC) algorithm. The RANSAC algorithm is an algorithm in which random sampling, calculation of model parameters (parameters representing a plane), and evaluation of correctness of the calculated model parameters are repeated until an optimum evaluation value is obtained. Hereinafter, a specific procedure will be described.

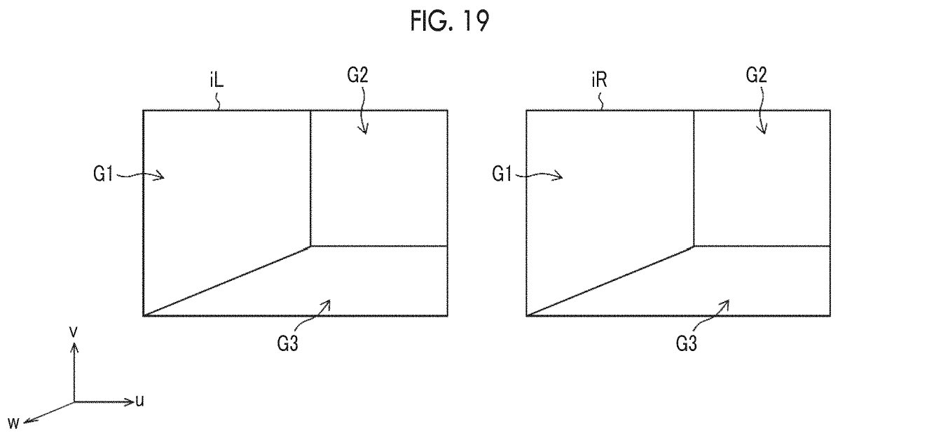

FIG. 19 shows an example of a left eye image iL in a stereo image generated by imaging an object to be imaged having planar regions by the stereo camera 202.

Three planar regions (first planar region G1, second planar region G2, and third planar region G3) are planar regions of the bridge 1 (an example of an object to be imaged). There is a case where a planar region is present in each member constituting the bridge 1, and there is also a case where one member includes two or more planar regions.

(Step S101)

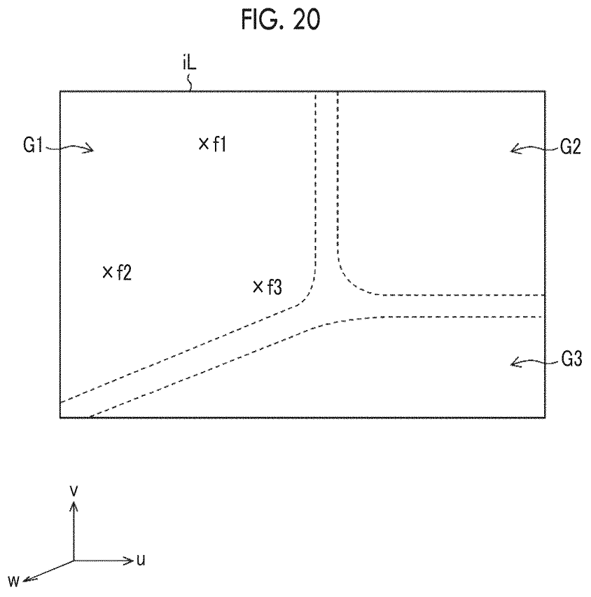

First, representative points are extracted from the image in a random manner. For example, it is assumed that a point f1 (u₁,v₁,w₁), a point f2 (u₂,v₂,w₂), and a point f3 (u₃,v₃,w₃) of FIG. 20 are extracted. The extracted representative points are points for deciding a plane equation (a form of a geometry equation) of each planar region (a form of a geometric region), and when the number of representative points is greater, a plane equation with higher accuracy (reliability) can be obtained. A horizontal coordinate of the image is represented by uᵢ, a vertical coordinate is represented by vᵢ, and parallax (corresponding to a distance) is represented by wᵢ (i is an integer greater than 1 representing a point number).

(Step S102)

Next, the plane equation is decided from the extracted points f1, f2, and f3. A plane equation F in a three-dimensional space (u,v,w) is generally represented by the following expression (a, b, c, and d are constants).

F=a×u+b×v+c×w+d (4)

(Step S103)

For all pixels (uᵢ,vᵢ,wᵢ) of the image, a distance to the plane represented by the plane equation F of Expression (4) is calculated. In a case where the distance is equal to or less than a threshold, determination is made that the pixel is present on the plane represented by the plane equation F.

(Step S104)

In a case where the number of pixels that are present on the plane represented by the plane equation F is greater than the number of pixels regarding a present optimum solution, the plane equation F is set as an optimum solution.

(Step S105)

Steps S101 to S104 are repeated the decided number of times.

(Step S106)

One plane is decided with the obtained plane equation as a solution.

(Step S107)

Pixels on the plane decided until Step S106 are excluded from pixels to be processed (pixels for which a plane is to be extracted).

(Step S8)

Steps S101 to S107 are repeated, and in a case where the number of extracted planes exceeds a given number or the number of remaining pixels is smaller than a prescribed number, the processing ends.

With the above-described procedure, the planar region can be specified from the stereo image. In the example of FIG. 19, the three planar regions G1, G2, and G3 are specified. In the example, different planar regions are identified in this way, whereby the displacement amount of the imaging device can be calculated with high accuracy.

[Variation]

In the above-described embodiments, although a case where the stereo camera is used as the imaging device and the stereo image (two-viewpoint image) is captured has been described as an example, the invention is not limited to such a case. The invention may also be applied to a case where a non-stereo camera is used as an imaging device and a single-viewpoint image is captured.

In a case where the first image and the second image are single-viewpoint images, a three-dimensional information acquisition unit (for example, a depth sensor) that acquires three-dimensional information of the object to be imaged is provided in an imaging control device 10 (10A, 10B, or 10C), and the plane specification unit 22 specifies the planar regions of the object to be imaged in the first image and the second image based on the three-dimensional information acquired by the three-dimensional information acquisition unit.

The second embodiment and the third embodiment described above may be carried out in combination.

In the above-described embodiments, although a case where the position and the attitude of the imaging device in the robot attached to the object to be imaged are displaced has been described as an example, the invention is not limited to such a case. For example, an imaging device may be mounted on a drone (unmanned flying object), and the drone may be controlled to displace the position and the attitude of the imaging device.

In the above-described embodiments, the plane specification unit 22, the feature point extraction unit 24, the correspondence relationship acquisition unit 26, the displacement amount calculation unit 28, the displacement control unit 30, the coincidence degree calculation unit 32, the damage detection unit 34, the integral control unit 38, and the display control unit 46 shown in FIGS. 1, 5, and 10 can be constituted of various processors described below. Various processors include a central processing unit (CPU) that is a general-purpose processor executing various kinds of information by software (program), a programmable logic device (PLD) that a processor capable of changing a circuit configuration after manufacture, such as a field programmable gate array (FPGA), a dedicated electric circuit that is a processor having a circuit configuration dedicatedly designed for executing specific processing, such as an application specific integrated circuit (ASIC), and the like. In the above-described embodiments, the functions of the imaging control device 10 (10A, 10B, or 10C) may be implemented by one of various processors or may be implemented by the same type or different types of two or more processors (for example, a plurality of FPGAs or a combination of a CPU and an FPGA). A plurality of functions may be implemented by one processor. As an example where a plurality of functions are implemented by one processor, as represented by system on chip (SoC) or the like, there is a form in which a processor that implements all functions of a system including a plurality of functions into one integrated circuit (IC) chip is used. In this way, various functions are implemented using one or more processors among various processors described above as a hardware structure. In addition, the hardware structure of various processors is, more specifically, an electric circuit (circuitry) in which circuit elements, such as semiconductor elements, are combined.

Although the mode for carrying out the invention has been described above, the invention is not limited to the embodiments and the modification examples described above, and various modifications may be made without departing from the gist of the invention.

### EXPLANATION OF REFERENCES

1: bridge
2: main girder
3: cross beam
4: cross frame
5: lateral frame
6: deck slab
10 (10A, 10B, 10C): imaging control device
12: first image acquisition unit
14: second image acquisition unit
22: plane specification unit
24: feature point extraction unit
26: correspondence relationship acquisition unit
28: displacement amount calculation unit
30: displacement control unit
32: coincidence degree calculation unit
34: damage detection unit
38: integral control unit (a form of “determination unit”)
40: storage unit
42: display unit
44: instruction input unit
46: display control unit
50: database
60: imaging device
60A: first imaging device
60B: second imaging device
70: displacement drive unit
100: robot device
102: main frame
104: vertical telescopic arm
104A: camera mounting portion
106: housing
108: X-direction drive unit
108A: ball screw
108B: ball nut
108C: motor
110: Y-direction drive unit
110A, 110B: tire
112: Z-direction drive unit
120: pan/tilt mechanism
130: position control unit
202: stereo camera
202A: first imaging unit
202B: second imaging unit
204: camera control unit
206: pan/tilt drive unit
210: attitude control unit
230: robot-side communication unit
300: terminal device
310: terminal-side communication unit
320: terminal control unit
330: instruction input unit
340: display unit
350: storage unit
400: operation controller
CA1: imaging inclination angle
CA2: imaging inclination angle
CR: crack image
G1: first planar region
G2: second planar region
G3: third planar region
iL: left eye image
IMG1: first image
IMG2: second image
IMG3: third image
iR: right eye image
L1, L2: optical axis
OBJ: object to be imaged
P: pan axis
P11 to F17, F21 to F30: feature point
T: tilt axis

What is claimed is:

1. An imaging control device comprising:
a first image acquisition unit that acquires a first image generated by imaging an object to be imaged by a first imaging device,
a second image acquisition unit that acquires a second image generated by imaging the object to be imaged by a second imaging device;
a feature point extraction unit that extracts feature points from the first image and the second image, respectively, the feature point extraction unit extracting feature points on the same plane of the object to be imaged in the first image and the second image;
a correspondence relationship acquisition unit that acquires a correspondence relationship between the feature point extracted from the first image and the feature point extracted from the second image, the correspondence relationship being a correspondence relationship between the feature points on the same plane of the object to be imaged;
a displacement amount calculation unit that, based on the correspondence relationship between the feature points on the same plane of the object to be imaged, calculates displacement amounts of a position and an attitude of the second imaging device such that differences from a position and an attitude of the first imaging device in a case where the first image is captured fall within given ranges;
a three-dimensional information acquisition unit that acquires three-dimensional information of the object to be imaged; and
a plane specification unit that specifies planar regions of the object to be imaged in the first image and the second image based on the three-dimensional information.

2. The imaging control device according to claim 1, further comprising
a displacement control unit that controls displacement of the position and the attitude of the second imaging device based on the displacement amounts calculated by the displacement amount calculation unit.

3. The imaging control device according to claim 2, further comprising:
a coincidence degree calculation unit that calculates a degree of coincidence between the first image and the second image; and
a determination unit that compares the degree of coincidence with a reference value to determine whether or not to displace the second imaging device,
wherein the displacement control unit displaces the second imaging device in a case where the determination unit determines to displace the second imaging device.

4. The imaging control device according to claim 3,
wherein the coincidence degree calculation unit calculates the degree of coincidence based on a difference between a position in the first image and a position in the second image of the feature points associated by the correspondence relationship acquisition unit.

5. The imaging control device according to claim 3,
wherein the displacement amount calculation unit calculates the displacement amounts in a case where the determination unit determines to displace the second imaging device.

6. The imaging control device according to claim 3,
wherein, in a case where the second imaging device is displaced by the displacement control unit, the acquisition of the image in the second image acquisition unit, the extraction of the feature points in the feature point extraction unit, the acquisition of the correspondence relationship in the correspondence relationship acquisition unit, and the calculation of the degree of coincidence in the coincidence degree calculation unit are repeated.

7. The imaging control device according to claim 1,
wherein the first image and the second image are a stereo image, and
the imaging control device further comprising
a plane specification unit that specifies planar regions of the object to be imaged in the first image and the second image based on the stereo image.

8. The imaging control device according to claim 1,
wherein the plane specification unit calculates a first plane equation for specifying the planar region of the object to be imaged in the first image and a second plane equation for specifying the planar region of the object to be imaged in the second image, and
the correspondence relationship acquisition unit acquires the correspondence relationship between the feature points on the same plane of the object to be imaged using the first plane equation and the second plane equation.

9. The imaging control device according to claim 1, further comprising
a damage detection unit that detects damage patterns of the object to be imaged from the first image and the second image,
wherein, in a case where a damage pattern that is not present in the first image and is present in the second image is detected, the displacement amount calculation unit calculates a displacement amount for registering the damage pattern to a specific position of a third image to be acquired by the second image acquisition unit.

10. The imaging control device according to claim 1, further comprising:
a display unit; and
a display control unit that makes the display unit display the first image and the second image in parallel or in a superimposed manner.

11. An imaging control method comprising:
a step of acquiring a first image generated by imaging an object to be imaged by a first imaging device;
a step of acquiring a second image generated by imaging the object to be imaged by a second imaging device;
a step of extracting feature points from the first image and the second image, respectively, the step being a step of extracting feature points on the same plane of the object to be imaged in the first image and the second image;
a step of acquiring a correspondence relationship between the feature point extracted from the first image and the feature point extracted from the second image, the correspondence relationship being a correspondence relationship between the feature points on the same plane of the object to be imaged;
a step of, based on the correspondence relationship between the feature points on the same plane of the object to be imaged, calculating displacement amounts of a position and an attitude of the second imaging device such that differences from a position and an attitude of the first imaging device in a case where the first image is captured fall within given ranges;
a step of acquiring three-dimensional information of the object to be imaged; and
a step of, based on the three-dimensional information, specifying planar regions of the object to be imaged in the first image and the second image.

12. A non-transitory, computer-readable tangible recording medium which records a program causing a computer to execute:
a step of acquiring a first image generated by imaging an object to be imaged by a first imaging device;
a step of acquiring a second image generated by imaging the object to be imaged by a second imaging device;
a step of extracting feature points from the first image and the second image, respectively, the step being a step of extracting feature points on the same plane of the object to be imaged in the first image and the second image;
a step of acquiring a correspondence relationship between the feature point extracted from the first image and the feature point extracted from the second image, the correspondence relationship being a correspondence relationship between the feature points on the same plane of the object to be imaged; and
a step of, based on the correspondence relationship between the feature points on the same plane of the object to be imaged, calculating displacement amounts of a position and an attitude of the second imaging device such that differences from a position and an attitude of the first imaging device in a case where the first image is captured fall within given ranges;
a step of acquiring three-dimensional information of the object to be imaged; and
a step of, based on the three-dimensional information, specifying planar regions of the object to be imaged in the first image and the second image.
